(19) United States
(12) Patent Application Publication
(10) Pub. No.: US 2006/0214961 A1
(43) Pub. Date: Sep. 28, 2006

(54) Ink jet printer and preliminary-ejection control method

(75) Inventor: Yasunori Nakahara, Ibaraki (JP)

Correspondence Address: DELLETT & WALTERS, P. O. BOX 82788, PORTLAND, OR, 97282-0788, US

(73) Assignee: Canon Finetech Inc.

(21) Appl. No.: 11/378,508

(22) Filed: Mar. 17, 2006

(30) Foreign Application Priority Data
Mar. 23, 2005 (JP) 2005-082951
Feb. 7, 2006 (JP) 2006-029807

(51) Int. Cl. B41J 29/38

(52) U.S. Cl. 347/14; 347/42

(57) ABSTRACT

The present invention makes it possible to continuously print for a long time with no print interruption and provides simple control for making a preliminary-ejected image pattern difficult to be visually recognized when paper preliminary-ejecting is performed on a printer that uses recording heads each having plural linearly-arranged ink-ejecting nozzles. To do so, a preliminary-ejection execution counter 303 is provided for counting the number of preliminary-ejection executions to determine nozzles, from which ink is ejected at each preliminary-ejection time, when ink is periodically ejected onto a recording medium from one or more nozzles at a time in a preliminary manner at a predetermined time during the image data recording operation through recording heads 509. The nozzles from which ink is ejected are determined based on a preliminary-ejection nozzle select value generated by exchanging the bit positions of the count value of the preliminary-ejection execution counter.

### DETAILED DESCRIPTION

1. Field of the Invention

The present invention relates to an ink jet printer that performs a so-called preliminary ejection for recovering the recording heads and the preliminary-ejection control method thereof.

2. Related Art

Conventionally, an operation called “preliminary ejection” has been performed on a printer, such as an ink jet printer, because ink is not always ejected from all the nozzles during the execution of recording. The “preliminary ejection” refers to the ejection of ink from the nozzles of the recording heads at a predetermined time, not to record image data, but to always keep the nozzles supplied with fresh ink even if those nozzle are not used for image data recording. This preliminary-ejection processing removes the causes of ink ejection failures, such as bubbles, dust, or high-viscosity ink thicken by the vaporization of solvent to such an extent that the viscosity is too high for the ink to be used recording and, in addition, adjusts the temperature of the head. This is achieved usually by ejecting ink from all ejection holes into a predetermined ink receiver composed, for example, of an ink absorber. Such preliminary ejection increases the stability of recording.

Japanese Utility Model Examined Publication No. Hei 3-45814 discloses a method for checking if the ejection signal is applied to the (whole) serial-type recording head during a predetermined period and, if the number of ejection signals (integrated value) is equal to or lower than a predetermined value, performing the preliminary ejection in the leading edge (margin) part in the next main scan of the head.

Another method used for a conventional ink jet printer is that, if ink is not ejected for a predetermined period, the preliminary ejection is performed in the paper fastening part of a recording medium (for example, Japanese Patent Laid-Open (Unexamined) Publication No. 2002-225301).

A still another method, proposed for a higher-resolution recording head, is that the preliminary ejection is performed in the recoding area of a recording medium when a predetermined time elapses (for example, Japanese Patent Laid-Open Publication No. 2002-144599).

The preliminary ejection according to the technology disclosed in Japanese Utility Model Examined Publication No. Hei 3-45814 and Japanese Patent Laid-Open Publication No. 2002-225301, which ejects ink in the margin or the paper fastening part of a recording paper, does not interrupt the print operation; however, this preliminary-ejection method is not suitable for continuous paper that has no margin or paper that has a long recording size. In particular, on a conventional ink jet printer that uses a long-type line head on which plural nozzles are arranged linearly across the full width of recording paper, the print operation is usually executed continuously for a relatively long time to continuously print on a continuous paper such as roll paper. In this case, the viscosity of the ink of a nozzle, from which ink is not ejected for a predetermined period, is increased with the result that the high-viscosity ink sometimes causes an ejection failure.

The so-called paper preliminary ejection that performs the preliminary ejection, not in the margin of recording paper but in the recording area as disclosed in the Japanese Patent Laid-Open Publication No. 2002-144599, if performed, solves this problem.

Wasteful ink consumption can be reduced by measuring the non-ejection period of each nozzle and by performing the preliminary ejection for nozzles for which ink is not ejected for a predetermined period; however, this method requires that the non-ejection period of each nozzle be measured. That is, this method requires time measuring means (for example, counters), one for each nozzle, and makes the control complex especially on a line head with a large number of nozzles.

In contrast, the preliminary ejection that is performed for the nozzles periodically regardless of a print image eliminates the need to provide the counters, one for each. However, the preliminary ejection that is performed for all nozzles at the same time or regularly involves the following problems. That is, though a recent recording head is extremely miniaturized and one printed droplet becomes so small that it is difficult to be visually recognized, there is a possibility that, when data ejected on paper is arranged in a line, the user can visually recognize the preliminary-ejected image pattern and therefore the recording quality is degraded.

In view of the foregoing, it is an object of the present invention to make it possible to continuously print for a long time with no print interruption and to provide simple control for making a preliminary-ejected image pattern difficult to be visually recognized when paper preliminary-ejecting is performed on a printer that uses recording heads on each of which plural ink-ejecting nozzles are arranged in a line.

### SUMMARY OF THE INVENTION

An ink jet printer according to the present invention comprises recording heads each having a plurality of linearly arranged nozzles from which ink is ejected; and preliminary-ejection means for causing one or more nozzles to periodically eject ink at a time onto a recording medium in a preliminary manner at a predetermined time during a recording operation of image data, wherein the preliminary-ejection means comprises a preliminary-ejection execution counter for counting a number of preliminary-ejection executions to determine nozzles, from which ink is preliminary-ejected, based on a preliminary-ejection nozzle select value generated by exchanging bit positions of a count value of the preliminary-ejection execution counter.

In this configuration, ink is not preliminary-ejected from all nozzles at a time from the recording head on which plural nozzles are linearly arranged. Instead, the preliminary-ejection execution counter for counting the number of preliminary-ejection executions is used to determine the nozzles, from which ink is ejected, based on the preliminary-ejection nozzle select value generated by exchanging the bit positions of the count value of the preliminary-ejection execution counter.

This configuration allows preliminary-ejected, recorded dots to be distributed on a recording medium.

The preliminary-ejection means exchanges the bit positions in such a way that high-order bits and low-order bits of the preliminary-ejection execution counter are replaced with reach other. Thus, the selection sequence of the nozzles, from which ink is preliminary-ejected, can be very easily distributed pseudo randomly.

The preliminary-ejection means adds preliminary-ejection data from nozzles, corresponding to a nozzle number of the preliminary-ejection nozzle select value, to image data corresponding to the plurality of nozzles and supplies the resulting data to the recording head. Thus, the preliminary-ejected data pattern can be processed as if it was included in the image data, and the subsequent image data print processing can be performed as in a conventional method.

The preliminary-ejection means comprises a preliminary-ejection spacing counter, provided for common use by all nozzles, for counting a number of recorded lines and, each time a predetermined number of lines are counted, updates the preliminary-ejection execution counter to indicate a time at which preliminary-ejection is to be performed. This configuration reduces the number of counters required.

The preliminary-ejection means changes the predetermined number of lines according to a print speed. Changing the predetermined number of line in this way prevents one round or time, required for preliminary-ejecting from all nozzles, from becoming extremely long due to a change in the print speed.

It is also possible that the preliminary-ejection execution counter is provided for common use by x partial nozzle groups, nozzles from which ink is preliminary-ejected are determined for all partial nozzle groups based on the value of the preliminary-ejection execution counter, and preliminary ejection is performed for each partial nozzle group, wherein the x partial nozzle groups are generated by dividing a total number of nozzles, N, of one recording head by x (x is an integer equal to or larger than 2). Dividing the total number of nozzles, N, of one recording head by x can reduce the number of bits required for the preliminary-ejection execution counter. In addition, performing preliminary ejection for each partial nozzle group will reduce the one round of time required for preliminary-ejecting ink from all nozzles (reduces the time at least by half).

It is also possible that the x preliminary-ejection execution counters are provided, one for each of x partial nozzle groups, nozzles from which ink is preliminary-ejected are determined for each partial nozzle group based independently on the value of the preliminary-ejection execution counter, and preliminary ejection is performed for each partial nozzle group, wherein the x partial nozzle groups are generated by dividing a total number of nozzles, N, of one recording head by x (x is an integer equal to or larger than 2). In this case, the initial value of the preliminary-ejection execution counter can be changed for each partial nozzle group to shift preliminary-ejected dot patterns in the plurality of areas in which images are printed by the partial nozzle groups.

It is also possible that a plurality of the recording heads are provided in parallel with each other and an initial value of the preliminary-ejection execution counters differs among the recording heads. Using different initial values prevents the same preliminary-ejected dot pattern from being generated by the recording heads.

According to the present invention, there is provided a preliminary-ejection control method of an ink jet printer comprising recording heads each having a plurality of linearly arranged nozzles from which ink is ejected. The preliminary-ejection control method comprises the steps of determining a time at which preliminary ink ejection is to be performed during a record operation of image data; updating a count value of a preliminary-ejection execution counter each time preliminary ejection is performed; and determining nozzles, from which ink is to be ejected, based on a preliminary-ejection nozzle select value generated by exchanging bit positions of the count value of the preliminary-ejection execution counter.

The bit positions of the preliminary-ejection execution counter are exchanged, for example, by replacing high-order bits with low-order bits.

### BRIEF DESCRIPTION OF THE DRAWINGS

FIG. 1 is a perspective view of the outline configuration of an ink jet printer in an embodiment of the present invention.

FIG. 2 is a block diagram showing the general hardware configuration of the ink jet printer shown in FIG. 1.

FIG. 3 is a diagram showing distributed preliminary ejection on recording paper of the present invention.

FIG. 4 is another diagram showing distributed preliminary ejection on recording paper of the present invention.

FIG. 5 is a diagram schematically showing the configuration for preliminary-ejection control in the embodiment of the present invention.

FIGS. 6A and 6B are diagrams showing the operation of a bit replacing unit in the embodiment of the present invention.

FIGS. 7A-7D are diagrams showing examples of preliminary-ejected image patterns and modifications of a preliminary-ejection execution counter in the embodiment of the present invention.

FIG. 8 is a flowchart showing basic print processing in the embodiment of the present invention.

FIG. 9 is a flowchart showing an example of processing in which a reference value is set variably according to a print speed in the embodiment of the present invention.

FIG. 10 is a diagram showing an example of the configuration of a preliminary-ejection period table used in the processing in FIG. 9.

FIG. 11 is a diagram showing how the preliminary-ejection execution frequency changes according to the feed speed in the embodiment of the present invention.

FIG. 12 is a diagram showing an example of the configuration in which the initial value of the preliminary-ejection execution counter value is changed for each recording head in the embodiment of the present invention.

### PREFERRED EMBODIMENTS OF THE INVENTION

With reference to the drawings, preferred embodiments of the present invention will be described in detail below using examples.

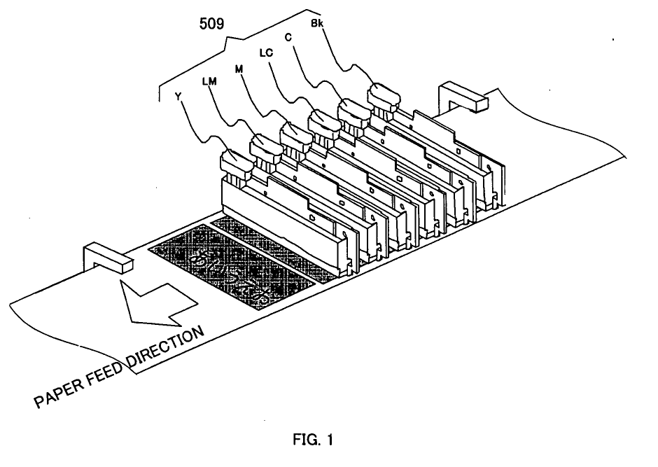

FIG. 1 is a perspective view of the outline configuration of an ink jet printer in an embodiment. Recording heads, used as recording means in this embodiment, are long-type line heads (Bk, C, LC, M, LM, Y) 509 each with plural, linearly arranged nozzles. The heads are arranged in parallel with each other in a direction perpendicular to the direction in which recording paper (recording medium) 101 is fed. Each recording head has N linearly arranged nozzles (N is a plural number) through which ink is ejected.

An ink jet printer shown as an example in FIG. 1 comprises the recording heads 509 composed of a recording head Bk that ejects black ink for recording, a recording head C that ejects cyan ink for recording, a recording head LC that ejects light cyan ink for recording, a recording head M that ejects magenta ink for recording, a recording head LM that ejects light magenta ink for recording, and a recording head Y that ejects yellow ink for recording.

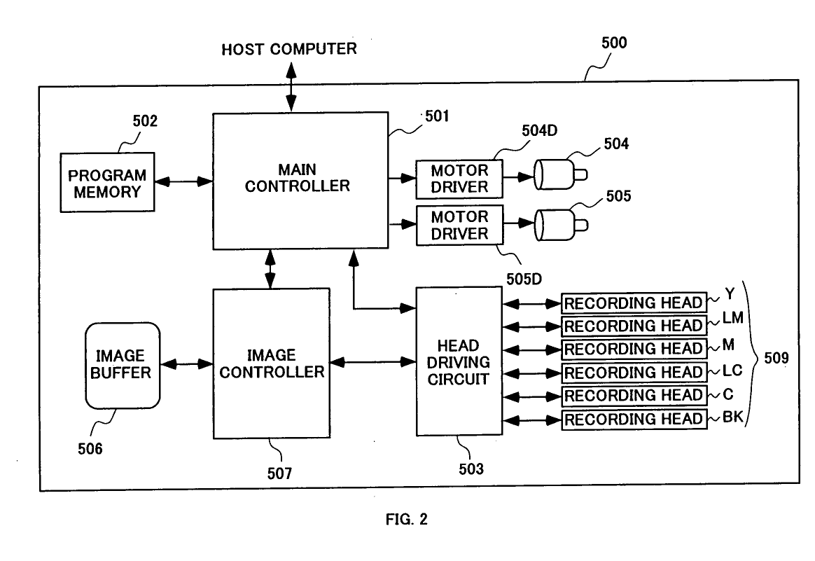

FIG. 2 is a block diagram showing the general hardware configuration of the ink jet printer shown in FIG. 1. A printer 500 comprises a main controller 501, a program memory 502, a head driving circuit 503, motor drivers 504D and 505D, a head lift motor 504, a recovery system 505, an image buffer 506, an image controller 507, and the recording heads 509.

The main controller 501, a component for controlling the whole printer 500, is connected to an external device such as a host computer to send and receive signals. Especially, the main controller 501 receives image data to be printed and commands for executing print processing.

The program memory 502 is a memory connected to the main controller 501 to store control programs therein. The driving circuit 503 is a driving circuit that drives a heater included in the recording head 509 of each color.

The motor driver 504D is a motor driver that drives the head lift motor 504 for lifting the recording heads 509 and moves them between the print position and the home position. The motor driver 505D is a motor driver that drives the recovery system motor 505 provided in the recovery system for sucking and ejecting high-viscosity ink present in the recording heads. Both motor drivers are controlled by the main controller 501.

The image controller 507 has a function to receive image data, sent from the host computer via the main controller 501, temporarily stores the data in the image buffer (recording data storage means) 506 in a predetermined data format (for example, bit map format) and, at the same time, reads this data during print execution to supply it to the head driving circuit 503.

The head driving circuit 503 has a function to control the ink ejection of the nozzles of the recording heads 509 based on the image data received from the image controller 507 under control of the main controller 501.

The following briefly describes the operation of the printer 500 shown in FIG. 2. When the printer 500 receives image data from the host computer via the main controller 501, the image controller 507 temporarily stores the image data once in the image buffer 506. When one sheet of image data is completed, the head lift motor 504 is driven to move the recording heads 509 from the home position to the print position. When recording paper that is fed reaches the print position, the image controller 507 connected to the main controller 501 controls the head driving circuit 503 according to the image data, stored in the image buffer 506, for forming an image by the recording heads 509.

The processing for receiving image data from the host computer and storing the data in the image buffer 506 can be executed in parallel with the processing for printing the image to print different images successively. When the printing is finished, the head lift motor 504 is driven to move the heads from the print position to the home position to finish the printing.

The ink jet recording heads are characterized in that, when they are kept exposed to air, the ink near the ejection nozzles dries, the ink viscosity increases, and a print error is generated. Therefore, the recovery processing must be performed for an ink jet printer, not only before but also during printing, before the head is exposed continuously for a predetermined period. One of standard recovery processing means is the preliminary-ejection means described above. Although this preliminary ejection increases the stability of recording, paper preliminary ejection must be performed to efficiently preliminary-eject ink without interrupting the printing. However, the preliminary ejection, if performed from all nozzles at the same time onto recording paper during printing, will form a linear image arranged in the longitudinal direction of the recording heads. Such a linear pattern, easily and visually recognizable by the user, degrades the quality of an actual print image. Thus, it is desirable that the preliminary-ejected dots be dispersed on recording paper to make it difficult for the user to visually recognize an image pattern generated by the preliminary ejection.

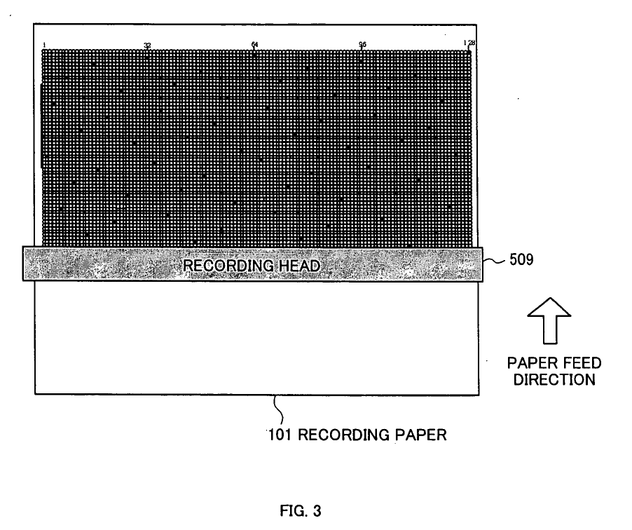

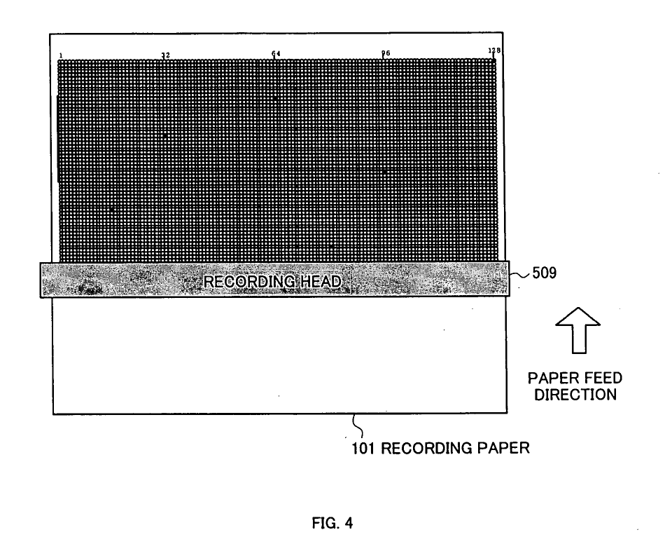

With reference to FIG. 3 and FIG. 4, the following describes distributed preliminary ejection on recording paper that prints images continuously with no interruption for the preliminary-ejection processing. Distributed preliminary-ejection is performed in such a way that ink is always ejected from all ejection nozzles during a predetermined period to prevent the recording heads from being continuously exposed to air. It should be noted that ink is ejected, not from all nozzles at a time, but from the nozzles in a predetermined period pseudo-randomly. “Pseudo-randomly” refers, not to the preliminary ejection that ejects ink completely randomly, but to the preliminary ejection that ejects ink according to a predetermined rule with the preliminary-ejection positions generated virtually randomly on the recording paper. Note, however, that the present invention does not eliminate complete “random preliminary ejection” from the scope thereof.

In the examples in FIG. 3 and FIG. 4, though a 128-nozzle recording head is used as an example for the sake of description, the actual recording head may have more nozzles (for example, 2560 nozzles). In the distributed preliminary-ejection shown in FIG. 3, ink is ejected from one nozzle in one line (a line that can be printed at a time in the longitudinal direction of the recording head). That is, the preliminary-ejection spacing is one line. In the figure, a black circle (●) indicates data that is preliminary-ejected, and a white circle (∘) indicates data that is not preliminary-ejected. This preliminary-ejected image is printed together with an actual print object image that is not shown in the figure.

In the distributed preliminary-ejection shown in FIG. 4, the preliminary-ejection spacing is 10 lines with one nozzle of preliminary ejection for every 11 lines. To make preliminary-ejected dots less conspicuous, the distributed preliminary-ejection spacing should be large. However, it should be noted that a one-round period, required for ink to be preliminary-ejected from all nozzles, should not exceed a continuous non-ejection time allowable for one nozzle. As will be described later, this one-round period depends also on the print speed. For one-nozzle preliminary-ejection at one preliminary-ejection time on one head, the time required for one round of preliminary ejections from all nozzles depends on the print speed.

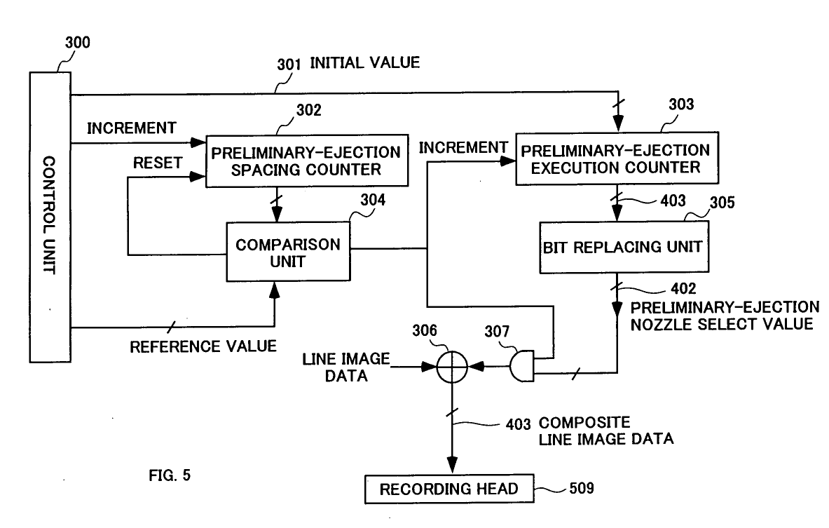

FIG. 5 is a diagram schematically showing the configuration of preliminary-ejection control in the embodiment of the present invention. A control unit 300 is a component for controlling preliminary ejection. For example, the main controller 501 shown in FIG. 2 can execute this function. A preliminary-ejection spacing counter 302, a counter for counting recorded lines, works together with a comparison unit 304, which compares the count value with the reference value, and determines the time at which preliminary ejection is to be performed. The reference value, given by the control unit 300, determines a line spacing at which preliminary ejection is to be performed. For example, to perform preliminary ejection for every 11 lines, the reference value is 10. When the initial value of the preliminary-ejection spacing counter 302 is 0, the count value reaches 11 when 11 lines are counted, the count value matches the reference value, the reset signal is generated, and the preliminary-ejection spacing counter 302 is reset to “0”. Each time the value of the preliminary-ejection spacing counter 302 reaches the reference value, a preliminary-ejection execution counter 303 is incremented. The preliminary-ejection execution counter 303, which is a counter for counting the number of lines on which preliminary ejection is performed, updates its value each time it receives the increment signal from the comparison unit 304. An initial value 301 of the preliminary-ejection execution counter 303 is supplied by the control unit 300. Although counted up in this example, the preliminary-ejection execution counter 303 may also be counted down. It is also possible to count down the preliminary-ejection spacing counter 302 with a positive number as its initial value and, when the reference value (for example, 0) is reached, to reset the counter to the initial value.

The count value in the preliminary-ejection execution counter 303 is treated as binary data, and a bit replacing unit 305 performs bit-replacing operation to exchange the high-order bits and the low-order bits. The number of bits, m, of the preliminary-ejection execution counter should be a value such that the m-th power of 2 is equal to or larger than the number of nozzles, N, of the recording head. When the m-th power of 2 is greater than N, it is desirable to reset the preliminary-ejection execution counter 303 when the count value of the counter reaches the total number of nozzles.

The data generated by exchanging the high-order bits and the low-order bits by the bit replacing unit 305 is called a preliminary-ejection nozzle select value. This preliminary-ejection nozzle select value is data specifying a nozzle for which preliminary ejection is to be performed. When the comparison unit 304 determines that the preliminary-ejection execution time arrives, this data is sent from an AND unit 307 to an OR unit 307 where this data and the line image data are ORed, bit by bit, to produce composite line image data 403. This composite line image data 403 is supplied to the corresponding head of the recording heads 509. The “Line image data” is a collection of binary data defining the on/off dots of an image allocated to the nozzles of one recording head. The composite line image data 403 determines whether to eject ink as follows. Ink is ejected from a nozzle, to which an on dot is allocated originally by the image data, regardless of the preliminary-ejection nozzle select value. On the other hand, ink is also ejected from a nozzle to which an on dot is not allocated by the image data but is specified by the preliminary-ejection nozzle select value.

The configuration shown in FIG. 5 can be configured not only by hardware but also by software processing by the main controller 501.

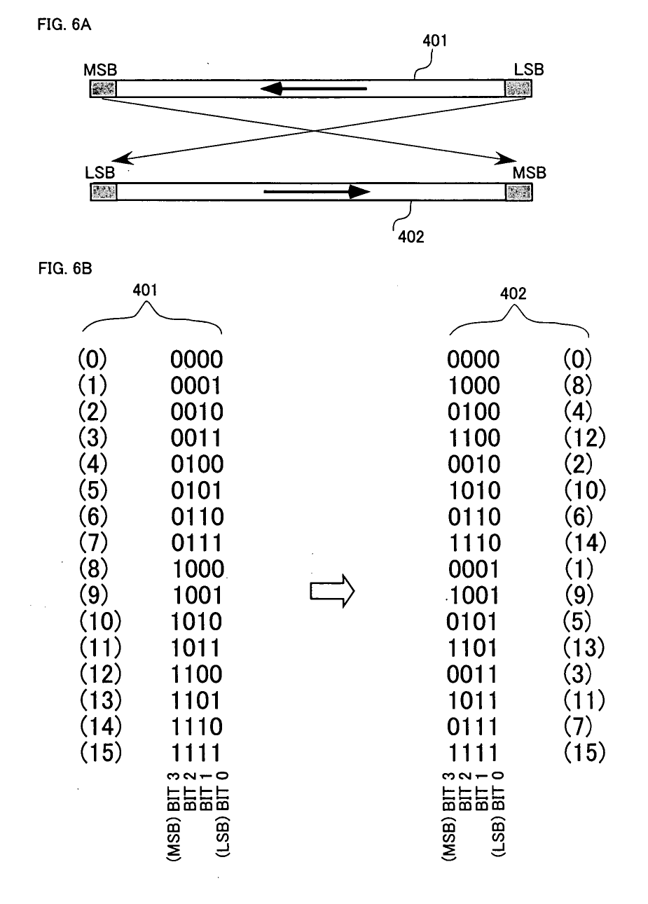

The following describes the operation of the bit replacing unit 305 in this embodiment more in detail with reference to FIGS. 6A and 6B. As shown in FIG. 6A, the high-order bits and the low-order bits of a binary count value 401 of the preliminary-ejection execution counter 303 are exchanged by the bit replacing unit 305 to produce a preliminary-ejection nozzle select value 402.

FIG. 6B shows an example of this processing using a 4-bit binary number. The number attached to the binary number with the parentheses is a decimal equivalent. As shown in this figure, the most significant bit (bit 3) of the count value 401 becomes the least significant bit (bit 0) of the preliminary-ejection nozzle select value 402, and the least significant bit (bit 0) of the count value 401 becomes the most significant bit (bit 3) of the preliminary-ejection nozzle select value 402. Bit 1 of the count value 401 becomes the bit 2 of the preliminary-ejection nozzle select value 402, and the bit 2 of the count value 401 becomes bit 1 of the preliminary-ejection nozzle select value 402. The figure shows that, as the value of the decimal number before the exchange is changed one at a time, the decimal number after the exchange is changed in such a way that the corresponding nozzle position is distributed. For the sake of simplicity, a count value of a small number of bits is used as an example. This processing can be applied also to a count value of a large number of bits.

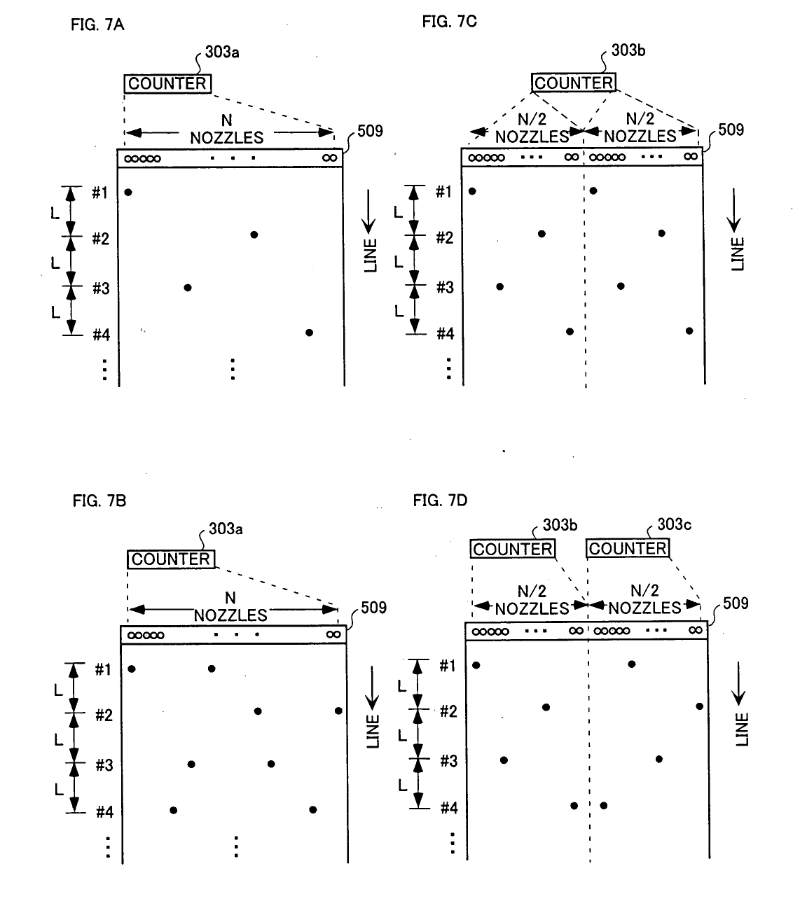

FIGS. 7A-7D show examples of preliminary-ejection image patterns in this embodiment and some modifications of the preliminary-ejection execution counter 303.

FIG. 7A shows a case where a preliminary-ejection execution counter 303a is a counter having the number of bits corresponding to the full width of the N-nozzle recording head 509 and where ink is preliminary-ejected only from one nozzle at one preliminary-ejection time. The preliminary-ejection spacing is L lines.

FIG. 7B shows a case where the same preliminary-ejection execution counter 303a that is shown in FIG. 7A is used and where ink is preliminary-ejected from plural nozzles at one preliminary-ejection time. One of those nozzles is a nozzle (called a determined nozzle) determined by the method described above. In addition, another nozzle can be selected as a nozzle having a predetermined relation with the determined nozzle. The “predetermined relation” is a relation, for example, characterized in that another nozzle is a predetermined number of nozzles distant from the determined nozzle (In this case, one end of the head is supposed to be connected to the other end to determine the distance between the nozzles).

FIG. 7C shows a case where all N nozzles of one head are divided by x (in this example, x=2) and preliminary ejection is performed individually for each partial nozzle group generated by the division. In this case, a counter 303b, corresponding to N/x (in this example, N/2) nozzles, is shared by the partial nozzle groups. That is, the preliminary-ejection image patterns for the partial nozzle groups are the same.

The example in FIG. 7D is similar to the example in FIG. 7C in that all N nozzles of one head are divided by x (in this example, x=2) and preliminary ejection is performed individually for each partial nozzle group generated by the division with the exception that dedicated preliminary-ejection execution counters, 303b and 303c, are provided for the partial nozzle groups, one for each. Different initial values, if set in those counters, can generate different preliminary-ejection image patterns for the partial nozzle groups (generated at different times).

The preliminary ejection for plural nozzles in one line, as in FIGS. 7B, 7C, and 7D, is efficient when the time required for one round of preliminary ejection for all nozzles (one-round preliminary-ejection period) is long, for example, when the line spacing is large or when the total number of nozzles, N, of the recording head is large. That is, preliminary ejection for plural nozzles inone line can shorten the one-round preliminary-ejection period. In addition, when the total number of nozzles, N, is large, preliminary ejection for plural nozzles in one line, if performed, has only a minimal effect on an actual image because the preliminary-ejected dots are distributed in the longitudinal direction of the recording head.

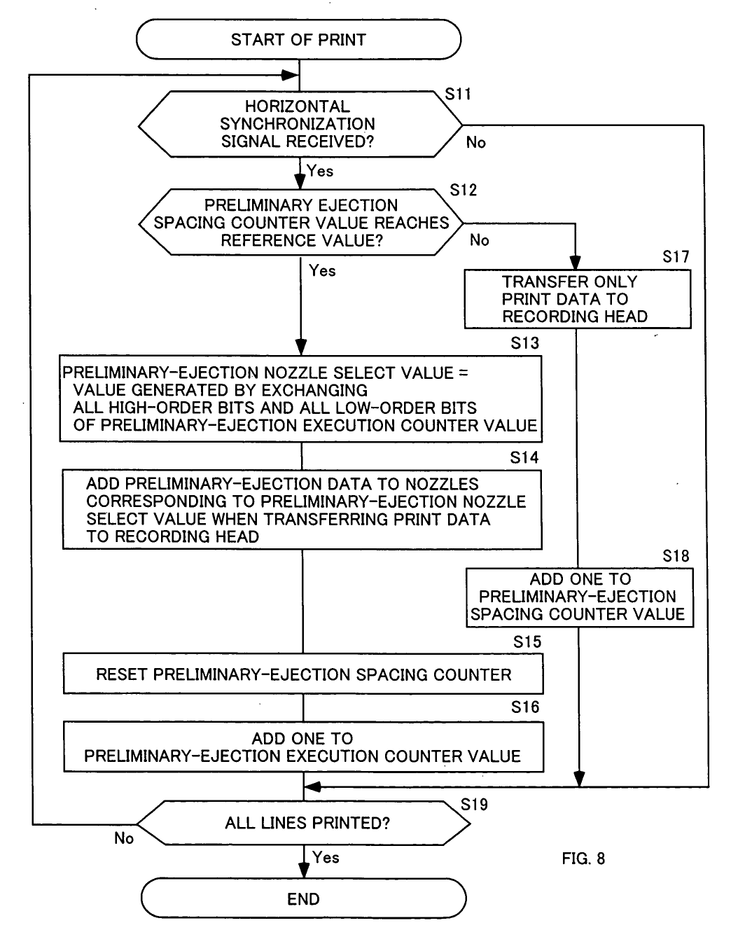

FIG. 8 shows a flowchart for the basic print processing in this embodiment. The main controller 501 in FIG. 2 reads a program from the program memory 502 to execute this processing. The processing shown in other flowcharts, which will be described later, is also executed in the same manner.

Printing on recording paper is carried out based on the horizontal synchronization signal that is supplied in synchronization with the recording paper feeding operation. When the print processing is started, the control unit waits for the horizontal synchronization signal (S11) and, when the horizontal synchronization signal is received, passes control to step S12.

In step S12, the comparison unit compares the preliminary-ejection spacing counter value with the reference value described above (preliminary-ejection spacing setting value). Until the preliminary-ejection spacing counter value reaches the reference value, only the print data is sent to the recording head (S17). In this case, the preliminary-ejection spacing counter value is incremented by one (S18) and control is passed to step S19.

When the preliminary-ejection spacing counter value reaches the reference value, control is passed to the flow for performing preliminary ejection. A value, generated by exchanging the high-order bits and the low-order bits of the preliminary-ejection execution counter, is assigned to the preliminary-ejection nozzle select value (S13). This preliminary-ejection execution counter value is a counter value with which at least the total number of nozzles of the recording head can be counted. Each time distributed preliminary-ejection is performed, preliminary-ejection data is added to the image data of the nozzles corresponding to the preliminary-ejection execution counter value (S14). If the preliminary-ejection execution counter value were assigned directly to the preliminary-ejection nozzle select value, the preliminary ejection would be performed sequentially from the first nozzle of the recording head and therefore a regular dotted line image is formed on the recording paper. In contrast, if a value generated by exchanging the high-order bits and the low-order bits of the preliminary-ejection execution counter is assigned, the recording nozzles can be selected pseudo randomly. When transferring print data to the recording head, the preliminary-ejection data is added to the image data of the recording nozzles corresponding to the preliminary-ejection select value and, as a result, the images such as those shown in FIG. 3 or FIG. 4 are recorded.

After step S14, the preliminary-ejection spacing counter is reset (S15) and the preliminary-ejection execution counter value is incremented (S16).

The above processing is repeated until the printing of all lines is finished (S19).

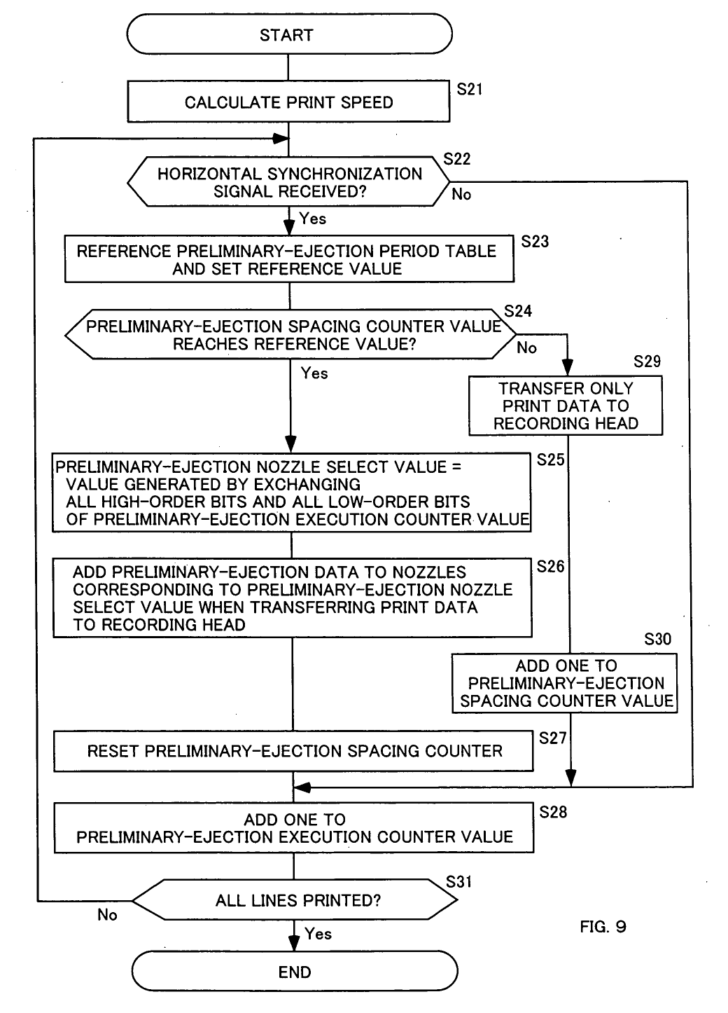

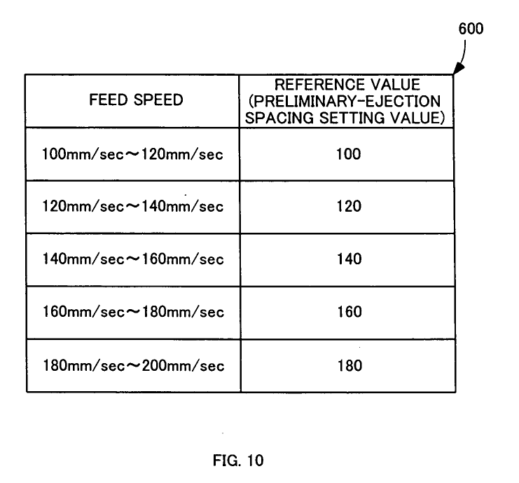

As described above, the reference value functions as a parameter for determining how often preliminary ejection is to be performed. Therefore, the larger the reference value is (that is, the less frequently the preliminary ejection is executed), the less conspicuous the preliminary-ejected ink on the recording paper becomes. On the other hand, because one round of distributed preliminary-ejection must be completed in a predetermined period, the preliminary-ejection execution frequency must be changed according to the recording paper feed speed or the head characteristics. With reference to FIG. 9, the following describes an example of processing in which the reference value can be variably set according to the print speed. FIG. 10 shows an example of the configuration of a preliminary-ejection period table 600 used for this processing. This preliminary-ejection period table 600 contains reference values (preliminary-ejection spacing setting values) corresponding to the print speeds, that is, the feed speeds of recording paper. As shown in the figure, the reference value is increased (that is, the preliminary-ejection execution frequency is decreased) as the feed speed becomes higher.

When the print processing is started in FIG. 9, the print speed is calculated first (S21). The printer can determine the print speed based on the information such as a print mode specified by the user. The control unit waits for the horizontal synchronization signal received (S22). When the horizontal synchronization signal is received, the control unit references the preliminary-ejection period table 600 and selects and sets the corresponding reference value (S23).

Next, the comparison unit compares the preliminary-ejection spacing counter value with the selected reference value (S24). The subsequent processing steps S25-S31 are the same as steps S13-S19 in FIG. 8 and, therefore, their description is omitted.

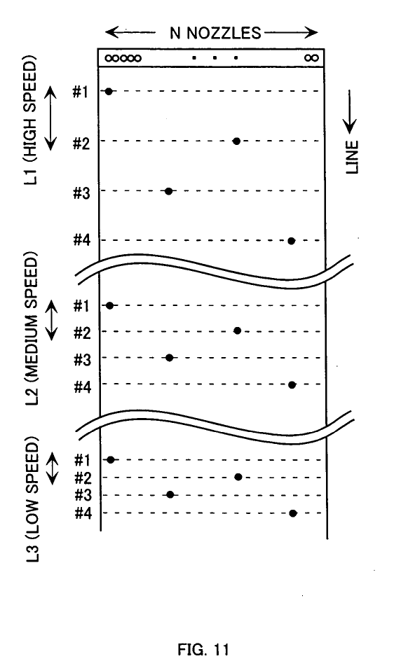

The above-described processing changes the preliminary-ejection execution frequency according to the feed speed as shown in FIG. 11. It should be noted that the “preliminary-ejection execution frequency” in this case refers, not to the number of preliminary-ejection executions per unit time, but to the number of lines for which one preliminary-ejection operation is performed. In the example shown in the figure, one preliminary-ejection operation is performed for L1 lines, L2 lines, and L3 lines (L1>L2>L3) respectively according to the three feed speeds “high”, “medium”, and “low”. The number of print lines per unit time increases as the speed increases and, therefore, the preliminary-ejection execution period is not so much affected even if the preliminary-ejection execution spacing (number of lines) becomes large.

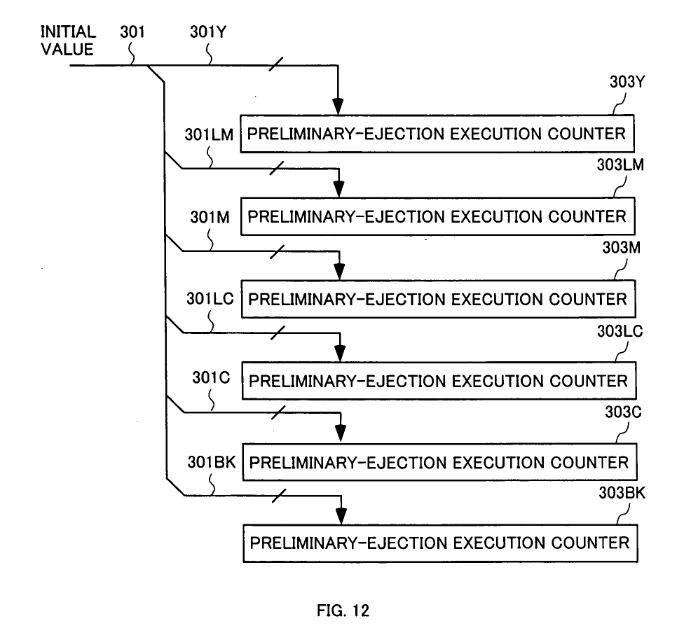

For a printer on which plural recording heads are mounted, distributed preliminary-ejection can be performed more pseudo randomly by changing the initial value of the preliminary-ejection execution counter so that the first nozzle from which ink is preliminary-ejected can be selected for each recording head. For example, as shown in FIG. 12, preliminary-ejection execution counters 303Y, 303LM, 303M, 303LC, 303C, and 303BK are provided respectively for the recording heads, and the initial values 301Y, 301LM, 301M, 301LC, 301C, and 301BK, which are different from each other, are set respectively in the counters. Although the initial values are set in parallel and concurrently in the counters in the figure, the initial values may also be set serially in the time-dividing manner. It is also possible that only one preliminary-ejection execution counter is provided for a recording head and that, each time preliminary-ejection is executed, a different value is added sequentially to the counter value at that time to calculate a preliminary-ejection execution counter value for some other recording head. The bit replacing operation and the addition of preliminary-ejection data to the line image data are performed separately for each recording head.

Although the present invention has been described with reference to the preferred embodiments, it will be appreciated that various modifications and changes may be made to the above described embodiments.

For example, although distributed preliminary-ejection of the present invention is always performed during printing in the above embodiments, it is also possible not to perform distributed preliminary-ejection in a non-continuous print operation mode.

The present invention eliminates the need to interrupt printing in order to perform preliminary ejection and allows the printer to continue printing until an error such as an ink run-out error occurs.

In addition, preliminary-ejected ink can be distributed pseudo randomly on paper with little or no influence on an image that is actually printed.

1. An ink jet printer comprising:
recording heads each having a plurality of linearly arranged nozzles from which ink is ejected; and
preliminary-ejection means for causing one or more nozzles to periodically eject ink at a time onto a recording medium in a preliminary manner at a predetermined time during a recording operation of image data, said ejection of ink not based on the image data;
wherein said preliminary-ejection means comprises a preliminary-ejection execution counter for counting a number of preliminary-ejection executions to determine nozzles, from which ink is preliminary-ejected, based on a preliminary-ejection nozzle select value generated by exchanging bit positions of a count value of said preliminary-ejection execution counter.

2. The ink jet printer according to claim 1 wherein the count value of said preliminary-ejection execution counter is a binary number.

3. The ink jet printer according to claim 1 wherein said preliminary-ejection means exchanges the bit positions in such a way that high-order bits and low-order bits of said preliminary-ejection execution counter are replaced with each other.

4. The ink jet printer according to claim 1 wherein said preliminary-ejection means adds preliminary-ejection data from nozzles, corresponding to a nozzle number of the preliminary-ejection nozzle select value, to image data corresponding to the plurality of nozzles and supplies the resulting data to said recording head.

5. The ink jet printer according to claim 1 wherein said preliminary-ejection means comprises a preliminary-ejection spacing counter, provided for common use by all nozzles, for counting a number of recorded lines and, each time a predetermined number of lines are counted, updates said preliminary-ejection execution counter to indicate a time at which preliminary ejection is to be performed.

6. The ink jet printer according to claim 5 wherein said preliminary-ejection means changes the predetermined number of lines according to a print speed.

7. The ink jet printer according to claim 1 wherein said preliminary-ejection execution counter is provided for common use by x partial nozzle groups, nozzles from which ink is preliminary-ejected are determined for all partial nozzle groups based on the value of said preliminary-ejection execution counter, and preliminary ejection is performed for each partial nozzle group, said x partial nozzle groups being generated by dividing a total number of nozzles, N, of one recording head by x (x is an integer equal to or larger than 2).

8. The ink jet printer according to claim 1 wherein x said preliminary-ejection execution counters are provided, one for each of x partial nozzle groups, nozzles from which ink is preliminary-ejected are determined for each partial nozzle group based independently on the value of said preliminary-ejection execution counter, and preliminary ejection is performed for each partial nozzle group, said x partial nozzle groups being generated by dividing a total number of nozzles, N, of one recording head by x (x is an integer equal to or larger than 2).

9. The ink jet printer according to claim 1 wherein a plurality of said recording heads are provided in parallel with each other and an initial value of said preliminary-ejection execution counters differs among said recording heads.

10. A preliminary-ejection control method of an ink jet printer comprising recording heads each having a plurality of linearly arranged nozzles from which ink is ejected, said preliminary-ejection control method comprising the steps of:
during a record operation of image data, determining a time at which preliminary ink ejection, not based on the image data, is to be performed;
updating a count value of a preliminary-ejection execution counter each time preliminary ejection is performed; and
determining nozzles, from which ink is to be ejected, based on a preliminary-ejection nozzle select value generated by exchanging bit positions of the count value of said preliminary-ejection execution counter.

11. The preliminary-ejection control method of an ink jet printer according to claim 10 wherein the count value of said preliminary-ejection execution counter is. a binary number.

12. The preliminary-ejection control method of an ink jet printer according to claim 10 wherein the bit positions of said preliminary-ejection execution counter are exchanged in such a way that high-order bits and low-order bits are replaced.

13. The preliminary-ejection control method of an ink jet printer according to claim 10 wherein preliminary-ejection data from nozzles, corresponding to a nozzle number of the preliminary-ejection nozzle select value, is added to image data corresponding to the plurality of nozzles and the resulting data is supplied to said recording head.

14. The preliminary-ejection control method of an ink jet printer according to claim 10 wherein a preliminary-ejection spacing counter is provided for common use by all nozzles, for counting a number of recorded lines and, and each time a predetermined number of lines are counted, said preliminary-ejection execution counter is updated to indicate a time at which preliminary ejection is to be performed.

15. The preliminary-ejection control method of an ink jet printer according to claim 14 wherein said preliminary-ejection means changes the predetermined number of lines according to a print speed.

16. The preliminary-ejection control method of an ink jet printer according to claim 10 wherein said preliminary-ejection execution counter is provided for common use by x partial nozzle groups, nozzles from which ink is preliminary-ejected are determined for all partial nozzle groups based on the value of said preliminary-ejection execution counter, and preliminary ejection is performed for each partial nozzle group, said x partial nozzle groups being generated by dividing a total number of nozzles, N, of one recording head by x (x is an integer equal to or larger than 2).

17. The preliminary-ejection control method of an ink jet printer according to claim 10 wherein x said preliminary-ejection execution counters are provided, one for each of x partial nozzle groups, nozzles from which ink is preliminary-ejected are determined for each partial nozzle group based independently on the value of said preliminary-ejection execution counter, and preliminary ejection is performed for each partial nozzle group, said x partial nozzle groups being generated by dividing a total number of nozzles, N, of one recording head by x (x is an integer equal to or larger than 2).

18. The preliminary-ejection control method of an ink jet printer according to claim 10 wherein a plurality of said recording heads are provided in parallel with each other and an initial value of said preliminary-ejection execution counter differs among said recording heads.
